(19) United States
(12) Patent Application Publication
(10) Pub. No.: US 2009/0309019 A1
(43) Pub. Date: Dec. 17, 2009

(54) FAIMS Apparatus Comprising Source of Dry Gas

(76) Inventors: Jonathan Richard Atkinson, Watford (GB); Alastair Clark, Dunstable (GB); William Angus Munro, Watford (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/442,058

(22) PCT Filed: Sep. 21, 2007
(86) PCT No.: PCT/GB2007/003597

§ 371 Date: Mar. 19, 2009

(30) Foreign Application Priority Data
Sep. 22, 2006 (GB) 0618669.6

(51) Int. Cl. H01J 49/26; H01J 49/04

(52) U.S. Cl. 250/282; 250/288

(57) ABSTRACT

An ion mobility spectrometer has an inlet opening into an ionization region including a conventional ionization source. A series of several charged, circular electrode plates with aligned apertures extending therethrough provides a drift region on the opposite side of the ionization region from the inlet. A gas inlet connected to a source of clean, dry flushing gas opens between the ends of the drift region, with the gas flowing against the ion flow to one side to remove water molecules from the analyte. Gas flowing in the opposite direction is effective to help drive the dry analyte ions to an analysis region provided by two parallel asymmetric field plates.

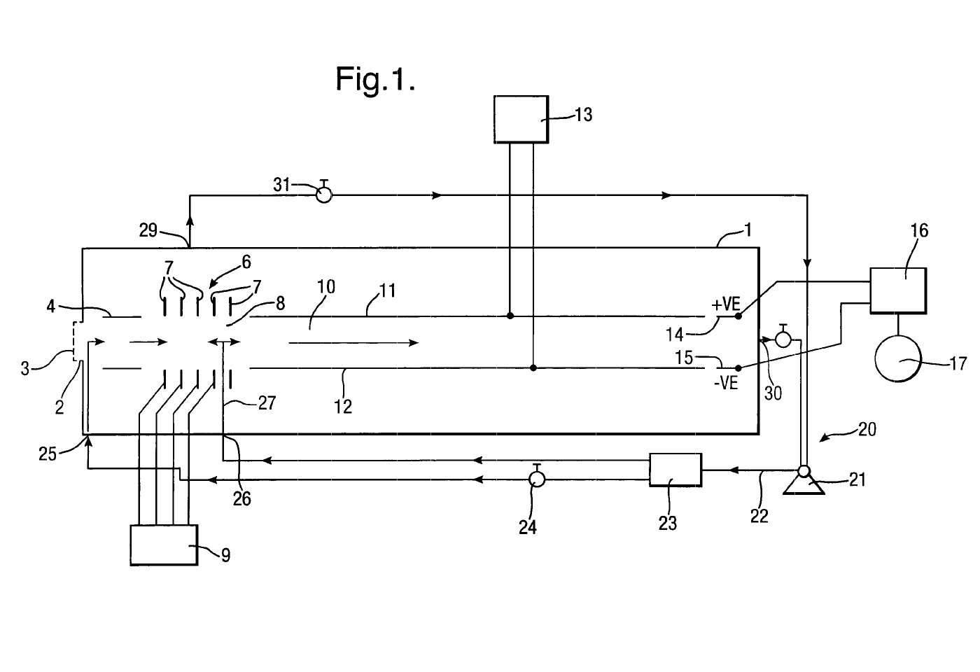

### BACKGROUND OF THE INVENTION

### Field of the Invention

This invention relates generally to detection apparatus, and more specifically to detection apparatus of the kind including a sample inlet, an arrangement for ionizing molecules entering the apparatus via the inlet, and a drift region in which an electric field is established to draw ions away from the ionizing arrangement to an asymmetric field region in which the ions are subject to an asymmetric field for detection.

Field asymmetric ion mobility spectrometers (FAIMS) or differential mobility spectrometers (DMS) have a filter region where an electrical field is produced transverse to direction of ion flow. By appropriately setting the electrical field certain ion species can be selected to flow through the filter for detection. Most FAIMS or DMS devices have an inlet that allows gas to flow from atmosphere and transfer ions from the region of the ion source. The gas is derived from the same source as is being sampled so it does not result in any dilution of the analyte sample. This can enable very low analyte levels to be detected. A problem with this arrangement is that there can be high levels of humidity in the sample. Water molecules, being polar, cluster with the ion species and, in doing so, vary the collision cross-section of the ion species moving through the ion filter and hence alter their mobilities. This causes movement of the observed position of the spectral peaks representing arrival of the ion species in the ion detection region of the instrument.

It is an object of the present invention to provide an alternative detection apparatus and method.

### SUMMARY OF THE INVENTION

According to one aspect of the present invention there is provided detection apparatus of the above-specified kind, characterized in that a source of dry gas is arranged to supply dry gas to the drift region at a location between its ends such that, for a first part of the path along the drift region, ions travel against the flow of the dry gas and, for a second part of the path, the ions travel with the flow of the dry gas. The drift region preferably includes a plurality of plates spaced from one another along the direction of travel of the ions. The plurality of plates may be arranged parallel with one another and each have an aperture therein through which the ions travel along the drift region. The asymmetric field region may include two plates extending parallel to the direction of travel and a detector located beyond the plates to detect ions passing through the two plates. The sample inlet may include a membrane permeable to the analyte, a pinhole, or a capillary inlet. The apparatus may also be arranged to supply dry gas to a location adjacent the inlet.

According to another aspect of the invention there is provided a method of detecting an analyte substance including the steps of introducing molecules of the substance via an inlet, ionizing molecules of the sample, drifting the ions formed by means of an electrical field in a direction away from the inlet and against the flow of a dry gas, subsequently drifting the ions in the same direction with the flow of the dry gas, subsequently admitting the ions to a region of a transverse electrical field so as to separate different ion species from one another, and detecting some of the ion species.

The method preferably includes the step of supplying dry gas adjacent an inside of the inlet.

### DESCRIPTION OF THE DRAWING

Detection apparatus and its method of operation, in accordance with the present invention, will now be described, by way of example, with reference to the accompanying drawing, which shows the detection apparatus schematically.

### DETAILED DESCRIPTION OF THE PREFERRED EMBODIMENT

The detection apparatus includes an elongate housing 1 with an inlet 2 at its left-hand end covered by a membrane 3. The membrane 3 allows molecules of the analyte of interest to enter the housing 1, but prevents some larger molecules, particles, and the like entering. Alternatively, the inlet 2 could have any other conventional means for restricting entry, such as a pinhole inlet, a capillary inlet, or the like. The interior of the housing 1 is at substantially atmospheric pressure, although there are various gas flow paths within the housing and outside it, as will be explained later. Ions of the analyte flow along the housing 1 generally from left to right as shown in the drawing. Located immediately adjacent the inlet 2 is an ionization source 4, which may be of any conventional kind such as a radioactive source, a corona discharge device, a photoionization source, or the like.

A drift region 6 to the right of the ionization source 4 as shown in the drawing is formed by a series of five guide electrode plates 7 extending transverse of the housing 1 axis and equally spaced parallel to one another. The electrode plates 7 are circular in shape with a central aperture 8 aligned axially with respect to the housing 1. The electrode plates 7 are connected with a voltage source 9 that is arranged to apply successively higher voltages to each plate in the series. Different numbers and arrangements of electrodes could be used.

The apertures 8 through the series of electrode plates 7 are aligned with a gap 10 between two closely-spaced FAIMS plates 11 and 12. The FAIMS plates 10 and 11 are flat and are connected to a conventional FAIMS power source 13. The FAIMS power source 13 applies an asymmetric alternating voltage superimposed on a DC compensation voltage across the two FAIMS plates 11 and 12, in the usual way. At the far end of the housing 1 remote from the inlet 2, and beyond the right-hand end of the FAIMS plates 11 and 12, are two small, flat detector plates 14 and 15. The detector plates 14 and 15 extend parallel with the axis of the housing 1 and are aligned parallel with the FAIMS plates 11 and 12 respectively. The detector plates 14 and 15 are connected to an amplifier and processor 16 responsive to the charge on the detector plates 14 and 15 to provide an output to a display or other utilization means 17 indicative of the identity of the analyte sampled.

The housing 1 is connected at various locations in a pneumatic gas-flow system 20. The gas flow system 20 includes a pump 21 having an outlet 22 connected to a molecular sieve 23, which produces clean dry air, and which may include a dopant or reagent in the manner described in U.S. Pat. No. 6,825,460. U.S. Pat. No. 6,825,460, to Breach et al. One outlet of the molecular sieve 23 connects via an adjustable restrictor 24 to a membrane gas inlet 25 close to the inlet end of the housing 1, between the inlet 2 and the ionization source 4, in the region of the membrane 3. This membrane gas flows from the inner surface of the membrane 3 to the right, to help carry analyte molecules from the membrane 3 to the ionization source 4.

The molecular sieve 23 has a second outlet, which connects with a second housing inlet 26 located downstream (in terms of the ion flow direction), to the right of the membrane gas inlet 25. The second inlet 26 is for flushing gas and is located between opposite ends of the drift region 6 series of electrode plates 7 and, more particularly, extends as a conduit 27 opening between the right-hand or downstream end electrode plate 7 and the adjacent electrode plate 7. Flushing gas flows out of the end of the conduit 27 in both directions, that is, downstream, towards the detector plates 14 and 15, and upstream, towards the inlet 2.

The gas-flow system 20 also includes two outlets 29 and 30 on the housing 1. One outlet 29 is located towards the inlet end of the housing 1 and, more particularly, is located upstream of the ion flow relative to the outlet of the conduit 27, that is, longitudinally between the two inlets 25 and 26. This outlet 29 connects via an adjustable restrictor 31 with an inlet of the pump 21. The other outlet 30 is located centrally at the right-hand end of the housing 1, downstream of detector plates 14 and 15. This outlet 30 may also connects via an adjustable restrictor with an inlet of the pump 21.

In operation, analyte molecules in sample air pass through the membrane 3 at the inlet 2 and are carried in the flow of membrane gas from the inlet 25 to the ionization source 4 where the molecules are ionized. The ion species produced continue flowing to the right under the combined effect of the flow of membrane gas and the opposite, attractive electrostatic charge on the left-hand electrode plates 7 in the drift region 6. When the ion species enter the drift region 6, the flow of gas from the outlet 26 against the ion flow exceeds that of the membrane gas flow so the ion species travel against the net gas flow, only under the influence of the electric field established in the drift region 6. This counter flow of dry gas is effective to remove water molecules from the analyte, which are carried via the outlet 29 to the pump 21 and the molecular sieve 23, where they are removed.

When the ion species come level with the flushing gas inlet 26, they experience a change of gas flow direction, which is now downstream, from left to right as shown in the drawing, and is effective to drive the ion species out and away from the drift region 6. This effect may be increased by arranging for the charge on the right-hand electrode plate 7 in the drift region 6 to be of the same sense as the charge on the ions so that a repulsive force is experienced by the ions species. The charge on the two FAIMS plates 11 and 12 is also such as to attract the ion species into the gap 10. The flushing gas from the inlet 26 flows to the right, downstream through the gap 10 and around the outside of the FAIMS plates 11 and 12 to the gas outlet 30 where it flows to a second inlet of the pump 21 for recirculation.

The ions species move along the gap 10 under the combined effect of the electrostatic field and the gas flow.

The applied FAIMS field acts to separate out the different ion species from one another and the DC compensation voltage applied to the FAIMS plates 11 and 12 is selected such that some at least of the ion species that are not of interest are attracted to one or other of the FAIMS plates 11 and 12 where they are neutralized. The remaining ion species flow along the entire length of the gap 10 without contacting the FAIMS plates 11 and 12 and are collected by one or other of the detector plates 14 or 15. Other FAIMS or DMS arrangements could be used.

The gas flow arrangement of the present invention enables a substantial reduction in the effect of humidity to be achieved in a FAIMS spectrometer.

Although the foregoing description of the detector apparatus present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A detection apparatus comprising:
a sample inlet;
an arrangement for ionizing molecules entering the apparatus via the inlet;
a drift region in which an electrical field is established to draw ions away from the ionizing arrangement to an asymmetric field region in which the ions are subject to an asymmetric field for detection;
a source of dry gas arranged to supply dry gas to the drift region at a location between its ends such that, for a first part of the path along the drift regions, ions travel against the flow of the dry gas and, for a second part of the path along the drift region, the ions travel with the flow of the dry gas.

2. A detection apparatus as defined in claim 1, wherein the drift region comprises:
a plurality of electrode plates spaced from one another along the direction of travel of the ions.

3. A detection apparatus as defined in claim 2, wherein the plurality of electrode plates are arranged parallel with one another and each have an aperture therein through which the ions travel along the drift region.

4. A detection apparatus as defined in claim 1, wherein the asymmetric field region comprises:
two FAIMS plates extending parallel to the direction of travel and a detector located beyond the FAIMS plates so as to detect ions passing through the two FAIMS plates.

5. A detection apparatus as defined in claim 1, wherein the sample inlet comprises:
a membrane permeable to the analyte, or a pinhole, or a capillary inlet.

6. A detection apparatus as defined in claim 1, wherein the detection apparatus is also arranged to supply dry gas to a location adjacent the inlet.

7. A method of detecting an analyte substance comprising the steps of:
introducing molecules of the substance via an inlet;
ionizing molecules of the sample;
drifting the ions formed by means of an electrical field in a direction away from the inlet and against the flow of a dry gas:
subsequently drifting the ions in the same direction with the flow of the dry gas:
subsequently admitting the ions to a region of a transverse electrical field so as to separate different ion species from one another; and
detecting some of the ion species.

8. A method as defined in claim 7, additionally comprising:
supplying dry gas adjacent an inside of the inlet.

9. A detection apparatus comprising:
a housing having an inlet end and an opposite outlet end, said outlet end being located downstream from said inlet end;
a sample inlet located in said housing at said inlet end;
an ionization source located in said housing proximate said inlet end, said ionization source ionizing molecules of an analyte entering said housing through said sample inlet;
a drift region located downstream from said ionization source, said drift region having an electrical field located therein which draws ions away from said ionizing source and toward an asymmetric field region located downstream from said drift region;
a source of dry gas, a first portion of which is supplied to the drift region at a location intermediate the ends thereof such that for a first part of the path along the drift region ions travel against the flow of the dry gas, and for a second part of the path along the drift region the ions travel with the flow of the dry gas;
wherein said ions passing through said asymmetric field region are separated into different ion species with a first plurality of ion species being neutralized and a second plurality of ion species continuing downstream from said asymmetric field region toward said outlet end of said housing; and
a detector located downstream of said asymmetric field region which detects said second plurality of ion species.

10. A detection apparatus as defined in claim 9, wherein said drift region is established by a plurality of parallel, spaced-apart electrode plates each having a coaxial aperture extending therethrough, said apertures being axially aligned with an axis extending from said inlet end of said housing to said outlet end of said housing, said plurality of electrode plates being located downstream from said ionization source and upstream from said asymmetric field region.

11. A detection apparatus as defined in claim 10, additionally comprising:
a voltage source that is arranged to apply successively higher voltages to said electrode plates ranging from the lowest voltage on the most upstream one of said electrode plates to the highest voltage on the most downstream one of said electrode plates.

12. A detection apparatus as defined in claim 10, wherein said first portion of said dry gas is provided to said drift region at a location intermediate a pair of said electrode plates.

13. A detection apparatus as defined in claim 12, wherein said first portion of said dry gas is provided to said drift region at a location intermediate the furthest downstream of said electrode plates and the one of said electrode plates plated adjacent to said furthest downstream of said electrode plates.

14. A detection apparatus as defined in claim 9, wherein said asymmetric field region is established by a pair of closely-spaced-apart FAIMS plates extending parallel to an axis extending from said inlet end of said housing to said outlet end of said housing.

15. A detection apparatus as defined in claim 14, additionally comprising:
a voltage source that is arranged to apply an asymmetric alternating voltage superimposed on a DC compensation voltage across said pair of FAIMS plates, said DC compensation voltage being selected such that said first plurality of ion species are attracted to one or other of said pair of FAIMS plates where they are neutralized.

16. A detection apparatus as defined in claim 9 additionally comprising:
a membrane covering said sample inlet, said membrane allowing molecules of an analyte of interest to enter said housing, but preventing larger molecules, particles, and the like from entering said housing.

17. A detection apparatus as defined in claim 9, wherein a second portion of said dry gas is provided to said housing at a location adjacent said sample inlet.

18. A detection apparatus as defined in claim 17, wherein said dry gas has an first outlet from said housing at a location that is longitudinally intermediate the locations at which said first and second portions of said dry gas are supplied to said detection apparatus.

19. A detection apparatus as defined in claim 18, wherein said dry gas has a second outlet from said housing at said outlet end of said housing.

20. A detection apparatus as defined in claim 9, wherein said first portion of said dry gas flows both downstream towards said asymmetric field region, and upstream towards said sample inlet.
